(19) United States
(12) Patent Application Publication
(10) Pub. No.: US 2003/0226038 A1
(43) Pub. Date: Dec. 4, 2003

(54) Method and system for dynamic refinement of security policies

(76) Inventors: Gil Raanan, Zoran (IL); Chaim Linhart, Tel Aviv (IL)

Correspondence Address: BROWN, RAYSMAN, MILLSTEIN, FELDER & STEINER LLP, 900 THIRD AVENUE, NEW YORK, NY, 10022, US

(21) Appl. No.: 10/335,224

(22) Filed: Dec. 31, 2002

Related U.S. Application Data
(60) Provisional application No. 60/344,646, filed on Dec. 31, 2001.

(51) Int. Cl. H04L 9/00

(52) U.S. Cl. 713/201

(57) ABSTRACT

A computerized method is described for dynamically refining a security policy rule set. The security policy rule set is used to define legal and illegal actions to be taken on an application running a server from clients. The method involves aggregating a plurality of log entries from one or more log files to create a single set of log entries, grouping the log entries in the single set according to common characteristics and analyzing the groups of log entries to amend the security policy rule set. The method helps reduce the instances in which legal actions are rejected by the security policy rule set.

### PRIORITY CLAIM

This application claims priority from U.S. Provisional Patent Application No. 60/344,646, titled METHOD AND SYSTEM FOR DYNAMIC SECURITY POLICY CREATION AND REFINEMENT FOR APPLICATION USAGE, filed Dec. 31, 2001, Attorney Docket No. 3269/10P, which is hereby incorporated herein by reference in its entirety.

### RELATED PATENTS AND APPLICATIONS

This application is related to U.S. Pat. No. 6,311,278, titled METHOD AND SYSTEM FOR EXTRACTING APPLICATION PROTOCOL CHARACTERISTICS, filed Jul. 1, 1999, issued Oct. 30, 2001, which is hereby incorporated herein by reference in its entirety.

This application is also related to the following pending patent applications:

U.S. patent application Ser. No. 09/696,736, titled METHOD AND SYSTEM FOR VERIFYING A CLIENT REQUEST, filed Oct. 25, 2000, Attorney Docket Number 3269/8; and

U.S. patent application Ser. No. 09/800,090, titled SYSTEM FOR DETERMINING WEB APPLICATION VULNERABLITIES, filed Mar. 5, 2001, Attorney Docket Number 3269/9;

each of which application is hereby incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to networked computer system security. More particularly, the present invention relates to requests made by network clients to application servers and security techniques for recognizing the validity of such requests.

Today, Internet security is comprised of four elements:

1) antivirus protection on the desktop;

2) data encryption and authentication for transport;

3) firewalls and advanced routers as network-layer security; and

4) manual patching for application-layer security.

Encryption and virtual private networks, using algorithms such as SSL, provide security for data travelling over the public Internet. Firewalls prevent unauthorized network-layer access to the server systems on which applications reside. With respect to application-layer security, however, neither firewalls nor encryption schemes protect the web application itself.

When a network client such as an Internet browser requests an HTML page, an executable function, or other information from an application server, there is frequently request data generated at the client that is then submitted to the online application running on the server. Hackers can manipulate this request data and use the online application to gain use and control of the server using techniques such as buffer overflow attacks, hidden field manipulation, parameter tampering, stealth commanding, and other methods. Without proper security to detect and prohibit these attacks, a server is extremely vulnerable to these types of attacks launched from a client. Effective web application-layer security should ensure that an online application can only be used in a manner consistent with the intention of its developer and should prevent the unauthorized use of a resource or other information by hackers attempting to gain use and control of the server directly through the online application itself.

Traditional approaches to web application-layer security require developers to address security issues at each stage of the development cycle. This is a very costly and time-consuming process in which a programmer conducts a line-by-line review of the source code for an application and analyzes potential security loopholes which a hacker might exploit. This traditional manual approach to enabling web application-layer security often fails because programmers simply cannot keep up with the enormous volume of new software code in these applications and the standard industry practice of implementing frequent patches.

As disclosed in the above-referenced U.S. Pat. No. 6,311,278 and U.S. patent application Ser. Nos. 09/696,736 and 09/696,736, rules can be applied to filter HTTP requests and other application-layer requests. Any security system, however, no matter how accurate, will also generate false negatives. Applying a stringent preset rules-based security policy can result in legitimate requests being rejected when they do not conform directly to the established rule set. On the other hand, applying a preset rules-based security policy that is too liberal can result in security holes allowing a potential hacker to penetrate the application server. A balance must be struck between these two extremes.

One possible solution is a dynamic and adaptive security system. Such a system creates rules that make up a security policy, but the system is capable of refining these rules as part of an ongoing process to make the security policy more accurate. The above-referenced U.S. Pat. No. 6,311,278 describes a dynamic security algorithm and system that extracts the security policy out of outgoing web pages leaving the application server and being sent to the network client such as the requesting Internet browser. The '278 patent does not explicitly discuss automatically refining the security policies that are extracted from outgoing web pages. Without such automatic refinement, a users such as a system administrator or security officer would need to refine the security policy manually based on data they obtained from the security policies extracted from the outgoing web pages.

There is thus a need for improved security techniques and supporting software for more dynamically recognizing the validity of requests made by network clients to application servers. Further, there is a need for improved security techniques and supporting software to dynamically refine security policies relating to the validity of requests made by network clients to application servers.

### BRIEF SUMMARY OF THE INVENTION

The present invention addresses the issues discussed above relating to recognizing the validity of requests made by network clients to application servers.

The present invention includes methods and systems that generate dynamic security policies and rules to identify and permit legal requests that a client may make of a server-based online application. The methodology applies a rule set to a collection of transaction requests, such as error logs, to determine, based on these rules, if any of the transaction requests represent legitimate requests. When a determination is made that a transaction request represents a legitimate request, then that request is added to the rule set for use in similar future determinations.

In another embodiment, the above and other functions are achieved by a method and software for dynamically refining the current security policy and rule set of an application server online application to authorize additional legitimate requests from a network client. The method involves collecting error log entries generated by illegal requests according to the existing security policy and rule set. The method further involves segregating these error log entries according to type for the purposes of facilitating future analysis. In some instances, there may be multiple error logs on a single application server or across a distributed network of application servers, in which case the method also involves collecting and determining all errors contained in these multiple error logs. The method further involves software employing predefined heuristics to dynamically analyze these collected errors of illegal server application requests, identifying the errors that are actually false negatives and should have been permitted, and expanding the ranges of field properties of an appropriate rule of the security policy to permit such false negatives in the future.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing a network client and an application server configuration in accordance with one embodiment of the present invention;

FIG. 2 is a block diagram showing an application server in accordance with one embodiment of the present invention;

FIG. 3 is a flow chart depicting how requests are initially received and processed in accordance with one embodiment of the present invention; and

FIG. 4 is a flow chart depicting how error logs are processed to dynamically refine rules of the security policy in accordance with one embodiment of the present invention.

### DETAILED DESCRIPTION OF THE PREFERRED EMBODIMENTS

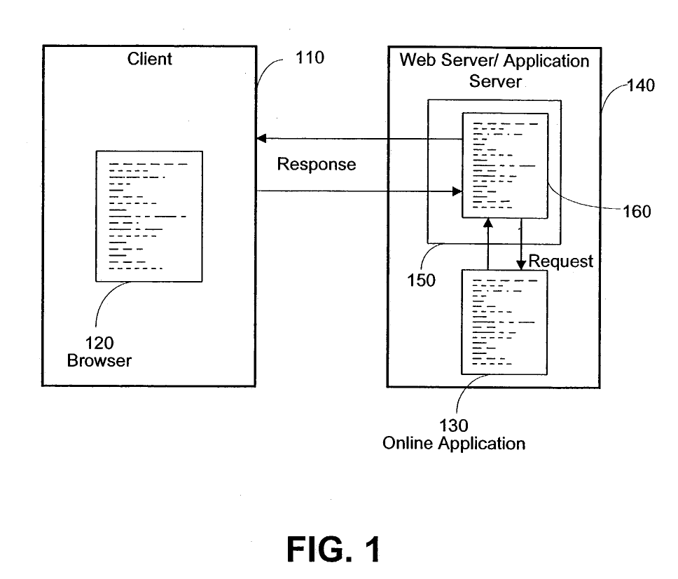

Preferred embodiments of the invention are now described with reference to the drawings. An embodiment of the system of the present invention is shown in FIG. 1. As shown, the system includes network clients 110, one of which is shown, each running a web browser 120 or other similar software application designed to communicate with an online application 130 running on an application server 140 or on multiple application servers 140, one of which is shown. Communications are filtered through an application security layer 150 which includes a dynamic policy recognition engine 160. The dynamic policy recognition engine, 160 analyzes requests, in accordance with a set of rules, or actions turned away and perhaps even those allowed by the application security layer and refines the security layer to reduce false negatives. These components may communicate over any known network, including wide area networks, local area networks, wireless networks, or the Internet.

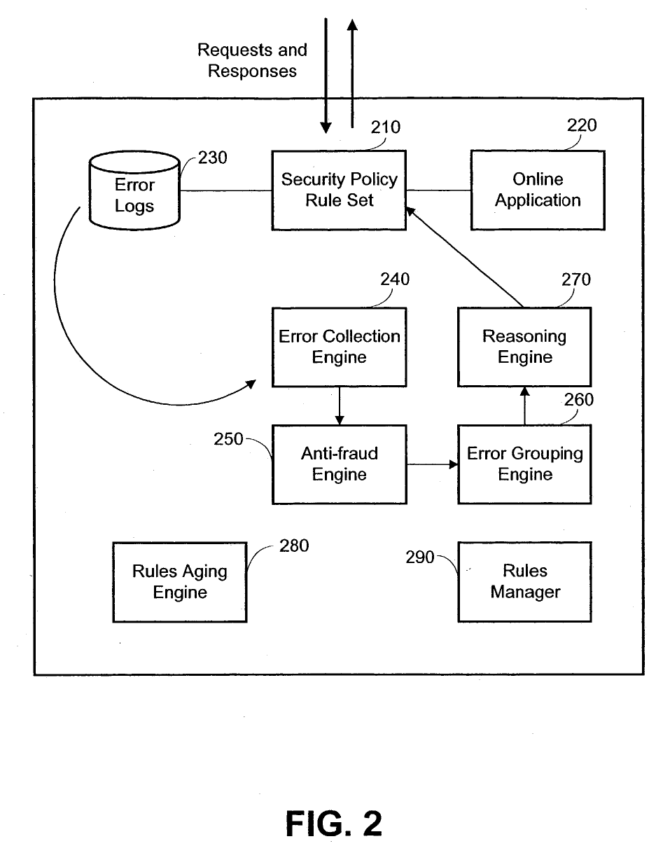

FIG. 2 shows selected elements of the invention residing on the application server 140. The invention contains a security policy rule set 210. Requests received by the application server 140 from the network client 110 are processed according to the rules contained in the security policy rule set 210. As disclosed in the above-referenced patents and applications, examples of items contained in the security policy rule set may include commands, fields, variable type definitions, and other common application-related items that can be combined to form a user request. The invention contains an online application 220 to which legal requests are passed. The invention contains an error log 230 which stores the details of requests that are rejected according to the security policy rule set 210. Request details may include the mutation, base, and field of each request as described below.

In some embodiments, the application server 140 may contain multiple error logs 230. Multiple error logs can occur if more than one security policy rule set 210 is in place. Multiple error logs can also occur in a distributed application server environment where each application server is generating its own error log or logs of rejected requests.

The server also contains an error collection engine 240. The errors collection engine 240 checks for multiple error logs 230 and aggregates the rejected request details contained in these multiple error logs 230 into one single set comprising all rejected requests resulting from all security policy rule sets 210.

Each request sent from the network client 110 to the application server 140 for execution by the online application 130 can be divided into several different parts including, in some embodiments, mutation, base, and field. The mutation includes a command or other executable instruction that the online application is requested to execute such as modifying or deleting a value in a database table or data structure. The base includes a path or location on the application server to execute the requested mutation. The field includes the database field or value in a data structure that the mutation will effect. Requests can also be divided into additional parameters know by those skilled in the art such as field length, data type, value range, and such. A typical error log entry providing details of an illegal request might resemble the following:

| Mutation | Base | Field | Additional Parameters |
|---|---|---|---|
| Modify Field | /x.com/bin/buy.asp | price | Field length, value, |
| | | | etc. |

The system also contains an error grouping engine 260 which evaluates the errors contained in the single log created by the error collection engine 240. These errors are sorted and grouped in the preferred embodiment according to their mutations, bases, and fields for future analysis.

The server contains an anti-fraud engine 250 which analyzes the different errors and groups from the set generated by the errors collection engine 240 and the set generated by the error grouping engine 260. Suspicious errors and groups are filtered out by the anti-fraud engine 250 and are not used to dynamically refine or create rules.

The server contains a reasoning engine 270. The reasoning engine 270 analyzes errors that are not rejected by the anti-fraud engine 250 and uses a set of heuristics to dynamically create or refine rules to be added to the security policy rule set 210.

To create a rule from such an error log requires a different level of understanding of the business logic, and implies a different level of security, on future requests. For example, in the case of an HTML Form, the length of the different field is guessed using a default value. (In case the Max-Length or Max-Size tags are missing.)

The dynamic policy recognition engine cannot, on the other hand, recognize the policy embedded in a JavaScript program downloaded together with an HTML page. An incoming HTTP request, which was generated by such JavaScript program, will be treated as an illegal request thus creating an error log entry. Traditionally in this scenario, a rule should be created, in case the error is a false positive. The new rule should allow this request to go through in the future. The rules creation typically should go through a generalization phase where the rule is created which will allow more requests than just this specific single request, by expanding the ranges of the field properties in the rule.

Examples of rules which might be generated from the exemplary error provided above might be as follows:

| | | | | |
|---|---|---|---|---|
| Action | Base | Field | Value | Length |

A naïve version of a rule:

| | | | | |
|---|---|---|---|---|
| Modify Field | /x.com/bin/buy.asp | price | <AlphaNumeric> | 100 |

A less naïve version of a rule:

| | | | | |
|---|---|---|---|---|
| Modify Field | /x.com/bin/buy.asp | price | <Integer> | <Max-Int> |

A even less naïve version of a rule:

| | | | | |
|---|---|---|---|---|
| Modify Field | /x.com/bin/buy.asp | price | range 100-199 | N/A (See |
| | | | | range) |

The invention also contains a rules aging engine 280 which analyzes the rules in the security policy rule set 210 and deletes non-required rules from the rule base. The rules aging engine 280 uses a set of heuristics to perform this analysis. Examples of rules which might be deleted by the rules aging engine 280 are old rules not applied for a particular period of time, similar rules, or overlapping rules (in which case the more broad rule is retained while the less-broad rule is deleted).

The invention contains a rules manager 290. The rules manager 290 is a user interface application that, for example, allows an application server administrator to adjust the various heuristics and parameters used to dynamically create or refine rules for the security policy rule set 210 among other features.

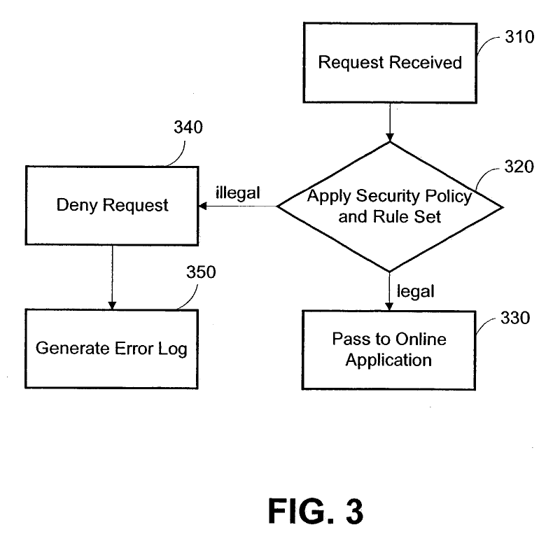

In accordance with the invention, and with reference to FIG. 3, a method of dynamically recognizing the validity of requests made by network clients to application servers first, step 310, receives a request at the application server. On the web, this request is usually delivered via HTTP, but this request may be delivered using any network communication protocol.

Once the request is received, it is filtered according to the security policy rule set, step 320. The security policy rule set identifies a set of legal actions that the user may potentially take and accordingly pass as a request from the network client sending the request to the online application. The security policy rule set is commonly structured according to the mutation, base, field, and other parameters of potential requests as previously discussed with respect to details extracted from illegal requests to generate error log entries.

If a request is identified as legal according to the security policy rule set, then the request is passed to the online application for processing, step 330. If the request does not match any of the rules contained in the security policy rule set, however, then the request will be treated as an illegal request and it will be denied, step 340. Illegal request details such as mutation, base, field, and other parameters will be extracted from the illegal request and used to create an error log entry, step 350. In alternative embodiments, legal requests are also logged and made available for use in the dynamic refinement process.

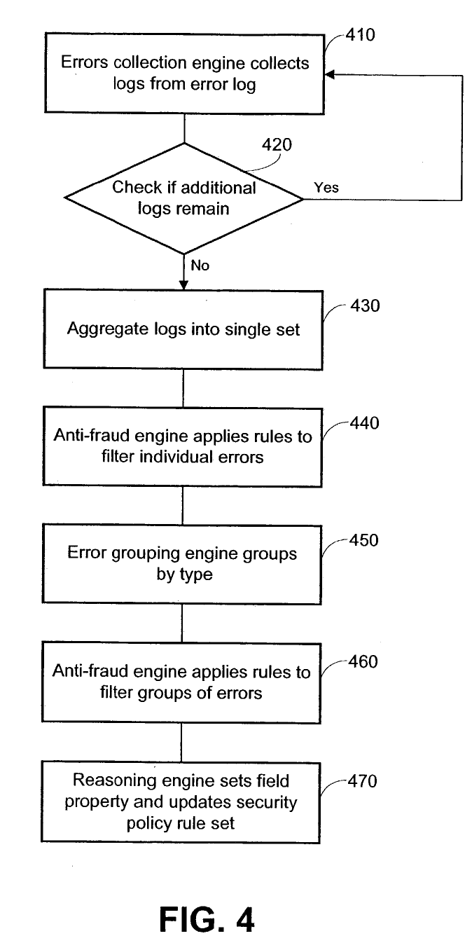

FIG. 4 is a flow chart depicting how error logs are processed to dynamically refine rules of the security policy rule set in accordance with one embodiment of the present invention. The errors collection engine accesses an error log to extract the log entries that the error log contains, step 410.

The errors collection engine checks to see if there are multiple error logs remaining to be processed, step 420. If there are multiple error logs, the errors collections engine continues to access all the different distributed error logs to extract the log entries they contain. The details of these different distributed error log entries are then aggregated to create a single set of all illegal requests as defined by the application server's security policy rule set, step 430. Although the preferred embodiment describes a single application server, multiple error logs may also occur on a single server or among many distributed application servers all utilizing the invention with each application server containing a single log or multiple logs and all of these logs being aggregated by the errors collection engine in steps 410 through 430.

Since the system and method of the current invention will ultimately make use of error logs to dynamically refine rules for the security policy rule set, care must be taken to ensure that newly created rules are derived from actual false negative error log entries as opposed to logs artificially generated by individuals seeking to gain control of the application server by sending repeated requests from different machines or the like. If such an individual were able to pass a request to the application server and generate an error log entry that was later dynamically refined and changed to be considered a legal request according to the security policy rule set, then that individual could potentially pass improper requests to the application server and have them seem legal.

The anti-fraud engine prevents such unauthorized use by analyzing different errors in the initial set of errors generated by the errors collection engine to filter out suspicious errors that will not be utilized to create rules, step 440. More specifically, the anti-fraud engine uses details contained in the error logs such as mutation, base, field, and other parameters combined with a set of user-definable heuristics to accurately identify and filter these potentially harmful errors. The user-definable heuristics allow for the anticipation of systematic activities as described above to intentionally generate error log entries.

The error grouping engine then analyzes all of the errors remaining in the initial set of errors and separates these errors into groups according to their mutation, base, field, and other parameters, step 450. These groups reflect illegal requests of the same kind that have repeatedly been rejected according to the rules of the security policy rule set.

Once the remaining errors are grouped by the error grouping engine, these groups of errors may also provide useful information relating to application security by examining them according to common characteristics shared by members of the same group. Thus, the anti-fraud engine examines each group of errors at the group level with respect to details such as mutation, base, field, and other parameters combined with a set of user-definable heuristics to accurately identify and filter these potentially harmful groups, step 460.

Once the anti-fraud engine has filtered out the suspicious errors and groups and the error grouping engine has separated error log entries, the remaining errors and groups are analyzed by the reasoning engine to create a rule that defines a legal action in the security policy rule set, step 470. The reasoning engine uses a set of user-definable heuristics to set the field properties of each dynamically refined rule that is created or modified. Such field properties might include default field length, default field value, field value generalization to alpha numeric, field value generalization to integer, field value generalization to letter, field value generalization to integer range, field value generalization to specific values, and similar properties. Each error log entry or group of similar illegal request error logs may potentially become a single dynamically refined rule that is added or amended to the current security policy rule set. Future incoming requests that correspond to this rule as defined in the security policy rule set will no longer be considered illegal requests, but will instead be treated as legal requests and passed on to the online application.

In embodiments which further analyze legal requests, the reasoning engine contains user-definable heuristics which analyze and compare other illegal and legal actions to define refined security rules.

The rules aging engine analyzes the rules contained in the security policy rule set and deletes non-essential or inefficient rules from the rule base. Human intervention in the dynamic rules refinement process is minimal and manual aging of the security policy rule set is not excessively contemplated. Since dynamic rules refinement occurs automatically, a large number of rules are likely to be created and to be added to the security policy rule set. The potential exists for degraded system performance due to the overhead of the additional rules added to the security policy rule set unless measures are taken to reduce this problem. The rules aging engine corrects this problem using a set of heuristics to conduct system performance tuning to eliminate duplicate rules and outdated rules, merge similar or overlapping rules, and engage in other performance-related tasks.

The methods and systems of the invention may be used either at the request of an administrator or done in real time periodically based on predefined criteria such as time based or event based execution. In either case, once the rules refinement process described above is complete, all filtered errors and groups, may be viewed in dedicated user interface screen, for manual manipulation. All default values may be manually configured by administrator in a dedicated user interface screen.

Rules need not only be generated by manually setting them or through actual dynamic use. An automatic crawler can run as a trusted client, none of whose requests are rejected by the rule set, which generates many requests in a very short time. This crawler will activate JavaScript programs, event-handlers and timers, submit forms with different inputs, follow links, and perform other common requests associated with online applications. Thus, a large rule set of legal requests can be accurately, safely, and automatically determined in a short period of time.

The rule manager is a user interface application that allows the user to adjust, for example, the various heuristics and parameters used to dynamically create or refine rules for the security policy rule set, the ability to identify and separate rules created manually from those created dynamically, and other similar administrative features.

Although the preferred embodiment describes dynamic rules refinement occurrng in essentially real time, it should be evident to those skilled in the art that this refinement could also take place offline during quality assurance testing or any other activity.

Although the preferred embodiment describes dynamic rules refinement occurring between a single client and a single application server, it should be evident to those skilled in the art that this refinement could take place among multiple clients and a single application server, among a single client and multiple application servers, and among multiple clients and multiple application servers.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A computerized method for dynamically refining a security policy rule set, the method comprising:
aggregating a plurality of log entries from one or more log files to a create a single set of log entries;
grouping the log entries in the single set according to common characteristics; and
analyzing the groups of log entries to amend the security policy rule set.

2. The method of claim 1, wherein aggregating a plurality of log entries comprises aggregating one or more error log entries.

3. The method of claim 1, wherein aggregating a plurality of log entries comprises aggregating one or more illegal requests as defined by the security policy rule set.

4. The method of claim 1, wherein aggregating a plurality of log entries comprises aggregating one or more legal requests as defined by the security policy rule set.

5. The method of claim 1, wherein aggregating a plurality of log entries from one or more log files comprises aggregating a plurality of log entries from one or more error log files.

6. The method of claim 1, wherein aggregating a plurality of log entries from one or more log files comprises aggregating a plurality of log entries from one or more log files generated by an application server.

7. The method of claim 1, wherein grouping the log entries comprises grouping the log entries according to the one or more of the characteristics of the group consisting of: a mutation, a base, and a field.

8. The method of claim 1, wherein amending the security policy rule set comprises creating a new rule in the security policy rule set.

9. The method of claim 1, wherein amending the security policy rule set comprises amending an existing rule in the security policy rule set.

10. The method of claim 9, wherein amending an existing rule comprises expanding a range of field properties associated with the existing rule.

11. The method of claim 10, wherein expanding the range of field properties comprises expanding the range one or more fields properties from the group comprising: a default field length, a default field value, a field value generalization to alpha numeric, a field value generalization to integer, a field value generalization to letter, a field value generalization to integer range, and a field value generalization to specific values.

12. An article of manufacture comprising a computer readable medium containing a program which when executed on a computer causes the computer to perform a method for dynamically refining a security policy rule set, the method comprising:
aggregating a plurality of log entries from one or more log files to a create a single set of log entries;
grouping the log entries in the single set according to common characteristics; and
analyzing the groups of log entries to amend the security policy rule set.

13. The article of manufacture of claim 12, wherein aggregating a plurality of log entries comprises aggregating one or more error log entries.

14. The article of manufacture of claim 12, wherein aggregating a plurality of log entries comprises aggregating one or more illegal requests as defined by the security policy rule set.

15. The article of manufacture of claim 12, wherein aggregating a plurality of log entries comprises aggregating one or more legal requests as defined by the security policy rule set.

16. The article of manufacture of claim 12, wherein aggregating a plurality of log entries from one or more log files comprises aggregating a plurality of log entries from one or more error log files.

17. The article of manufacture of claim 12, wherein aggregating a plurality of log entries from one or more log files comprises aggregating a plurality of log entries from one or more log files generated by an application server.

18. The article of manufacture of claim 12, wherein grouping the log entries comprises grouping the log entries according to the one or more of the characteristics of the group consisting of: a mutation, a base, and a field.

19. The article of manufacture of claim 12, wherein amending the security policy rule set comprises creating a new rule in the security policy rule set.

20. The article of manufacture of claim 12, wherein amending the security policy rule set comprises amending an existing rule in the security policy rule set.

21. The article of manufacture of claim 20, wherein amending an existing rule comprises expanding a range of field properties associated with the existing rule.

22. The article of manufacture of claim 21, wherein expanding the range of field properties comprises expanding the range one or more fields properties from the group comprising: a default field length, a default field value, a field value generalization to alpha numeric, a field value generalization to integer, a field value generalization to letter, a field value generalization to integer range, and a field value generalization to specific values.
